(19) United States
(12) Patent Application Publication
(10) Pub. No.: US 2026/0035307 A1
(43) Pub. Date: Feb. 5, 2026

(54) Polymer Derived Ceramic Material

(71) Applicant: National Technology & Engineering Solutions of Sandia, LLC, Albuquerque, NM (US)

(72) Inventors: William Corbin, Rio Rancho, NM (US); Ashley Danielle Cardenal, Albuquerque, NM (US); Clayton Curtis, Albuquerque, NM (US)

(21) Appl. No.: 19/285,013

(22) Filed: Jul. 30, 2025

Related U.S. Application Data
(60) Provisional application No. 63/678,624, filed on Aug. 2, 2024.

(51) Int. Cl. C04B 35/571

(52) U.S. Cl. CPC C04B 35/571; C04B 2235/483

(57) ABSTRACT

The present invention stands directed at polymer derived ceramic material. More specifically, boric acid and 2,4,6-trimethyl-2,4-6-trivinylsilazane are reacted to form a polymeric resin followed by the addition of a crosslinking agent and then subsequent crosslinking and pyrolysis to provide an improved ceramic yield.

### CROSS-REFERENCE TO RELATED APPLICATIONS

This application claims priority to U.S. Provisional Application No. 63/678,624, filed on Aug. 2, 2024, and entitled “Polymer Derived Ceramic Material”, the entirety of which is incorporated herein by reference.

### STATEMENT REGARDING FEDERALLY SPONSORED RESEARCH OR DEVELOPMENT

This invention was made with Government support under Contract No. DE-NA0003525 awarded by the United States Department of Energy/National Nuclear Security Administration. The U.S. Government has certain rights in the invention.

### FIELD

The present invention stands directed at polymer derived ceramic material. More specifically, boric acid and 2,4,6-trimethyl-2,4-6-trivinylsilazane are reacted to form a polymeric resin, optionally containing metallic filler, followed by crosslinking prior to pyrolysis to provide an improved ceramic yield.

### BACKGROUND

Polymer derived ceramics (PDCs) are formed by the pyrolysis of preceramic polymers. Preceramic polymers are reported to include, e.g., poly(organo)siloxanes which represent polysiloxanes with organic groups in the backbones. Other preceramic polymers are identified as polycarbosilanes and poly(organo)carbosilanes, which contain alternating carbon and silicone atoms in the backbones. Polymers made up of Si—N bonds are also utilized, which include polysilazane, poly(organosilazanes) and poly(organosilylcarbodiimides). In addition, ceramic powder has been reported via pyrolysis of boron-modified cyclotrisilazane (BCTS). See, e.g., Simple and Low-Cost Synthetic Route For SiBCN Ceramic Powder From A Boron-Modified Cyclotrisilazane, G. Thiyagarajan and R. Devasia, J. Am Ceram. Soc. 2019; 102:476-489.

PDCs have therefore been the subject of various research efforts due to their reported high-temperature properties along with resistance to oxidative and corrosive environments. Accordingly, the need always remains to improve the ceramic yield from PDCs and to mitigate shrinkage upon ceramic conversion.

### SUMMARY

A method to form polymer derived ceramic material comprising:
a. reacting boric acid and 2,4,6-trimethyl-2,4,6-trivinylcyclotrisilazane and forming a polymeric resin;
b. incorporating a chemical crosslinking agent in said polymeric resin wherein said chemical crosslinking agent provides a source of free-radicals at temperature of less than or equal to 225° C.;
c. heating said polymeric resin containing said chemical crosslinking agent and said active metal filler and crosslinking said polymeric resin at temperatures at or below 225° C.; and
d. pyrolyzing said crosslinked resin produced in step (c) and forming a ceramic at a ceramic yield of greater than or equal to 80.0%.

A method to form polymer derived ceramic material comprising:
a. reacting boric acid and 2,4,6-trimethyl-2,4,6-trivinylcyclotrisilazane and forming a polymeric resin;
b. incorporating a chemical crosslinking agent in said polymeric resin wherein said chemical crosslinking agent provides a source of free-radicals at temperatures of less than or equal to 225° C.;
c. exposing said polymeric resin containing said chemical crosslinking agent to ultraviolet radiation and crosslinking said resin at temperatures at or below 225° C.; and
d. pyrolyzing said crosslinked resin produced in step (c) and forming a ceramic at a ceramic yield of greater than or equal to 80.0%.

### BRIEF DESCRIPTION OF DRAWINGS

FIG. 1 shows results of thermogravimetric analysis and the ceramic yield of the identified BCTS15 resin control, the BCTS15 resin crosslinked with DCP prior to pyrolysis, and the BCTS15 resin crosslinked with DCP prior to pyrolysis that includes active metal filler. BCTS15 is referenced to the feature that the resin is produced from the reaction of boric acid with 2,4,6-trimethyl-2,4,6-trivinylcyclotrisilazane at a molar ratio of 1:5.

FIG. 2 shows the powder x-ray diffraction diagram of the BCTS15 resin crosslinked with 2,4,6-trimethyl-2,4,6-trivinylcyclotrisilazane (DCP) prior to pyrolysis and then pyrolyzed and the identification of molybdenum carbide in either the Mo₂C hexagonal close packed (triangle) or MoC face-centered cubic phase (star) in addition to some unreacted Mo (circle).

### DETAILED DESCRIPTION OF PREFERRED EMBODIMENTS

The polymer derived ceramic material herein initially relies upon two available precursors, boric acid (BA) and 2,4,6-trimethyl-2,4,6-trivinylcyclotrisilazane (CTS). The two precursors are preferably reacted by refluxing in the presence of water to form a polymeric resin. A liquid polymeric resin is produced, that can be conveniently characterized by molecular weight that can depend upon the molar ratio of BA to CTS, which is discussed further below. The number average molecular weight (Mn) as determined by gel permeation chromatography (GPC) may therefore preferably fall in the range of 1000 to 5000. The weight average molecular weight (Mw) also determined by gel permeation chromatography may preferably fall in the range of 1500 to 7,500.

With regards to the particular structure of the polymer resin so produced, ¹H, ¹³C NMR and FTIR characterization indicates that such polymer contains —Si—O—Si— linkages, —Si—O—B— linkages and —N—Si—O— linkages. In addition, one observes the presence of Si—CH₃ and Si—CH═CH₂ moieties in the polymer backbone. The polymerization reaction may also provide the following general reaction scheme to produce a random copolymer of the two indicated repeat units, where the values of the repeating units x and y are such that they can also provide the preferred molecular weight values noted herein.

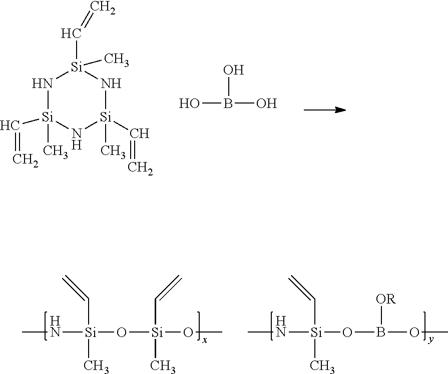

In addition, R in the formula may be a hydrogen (thereby providing a hydroxy —OH functionality) or it can amount to a link to a boron within another repeat unit. See below:

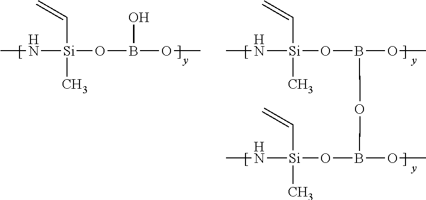

One can therefore preferably utilize a molar ratio of BA to CTS that provides an excess of CTS. Accordingly, the molar ratio of BA to CTS is preferably one mole of BA to more than one mole of CTS (1.0:>1.0), and even more preferably falls in the range of 1.0:>1.0 to 5.0, including all values and increments therein. Accordingly, the molar ratio of BA to CTS may therefore have values such as 1.0:2.0, 1.0:3.0, 1.0:4.0 or 1.0:5.0.

In addition, it is contemplated that one may also utilize a molar excess of BA to CTS, preferably >1.0:1.0 to 5.0:1.0. Therefore, the molar ratio of BA to CTS may have values such as 2.0:1.0, 3.0:1.0, 4.0:1.0 or 5.0:1.0. Whether one utilizes a molar excess of CTS to BA, or BA to CTS, one preferably controls such mole ratio to provide that the polymeric resin so produced remains a liquid at room temperature.

The polymeric resin so produced by the reaction of BA and CTS preferably indicates a viscosity at 25° C. in the range of 10.0 centipoise (cps) to 10,000 cps including all values and increments therein. More preferably, the viscosity is configured to fall in the range of 10.0 cps to 5000 cps, or 10.0 cps to 2500 cps. At this point, one introduces to the resin a chemical crosslinking agent, such as a chemical crosslinking agent that preferably provides a source of free radicals. Thermal activation of the chemical crosslinking agent is preferably applied at a temperature of less than or equal to 225° C. to provide free-radicals (molecules or an atom that contains an unshared electron). In addition, it is contemplated that one may utilize ultraviolet (UV) light to separately or in conjunction with thermal treatment, provide activation of the chemical crosslinking agent and promote the formation of free-radicals. Accordingly, the UV light can similarly be applied at temperatures of less than or equal to 225° C.

The chemical crosslinking agent is preferably selected from peroxides, and in particular organic peroxides, characterized by the presence or absence of a hydroxyl terminus (—OH) and by the presence of alkyl or acyl substituents in combination with a peroxide (—O—O—) linkage. Accordingly, the peroxides may have the general structure R—O—O—R′ where R provides alkyl or acyl functionality, and R′ may be a hydrogen (thereby providing hydroperoxide functionality) as well as alkyl or acyl functionality. Examples therefore include dicumyl peroxide (C₆H₅CMe₂O)₂, tert-butylperoxybenzoate (C₆H₅CO₃CMe₃) or dibenzoyl peroxide (C₆H₅—C(═O)O)₂. Of these, dicumyl peroxide (DCP) is particularly preferred, which has a thermal activation temperature of about 160-170° C. In such context, the peroxides selected herein are preferably those that indicate an activation temperature and generate free radicals at temperatures of less than or equal to 225° C., or in the preferred range of 50°° C. to 225° C.

The concentration of any such chemical crosslinking agent in the polymeric resin formed by the reaction of BA and CTS is preferably in the range of 0.1 wt. % to 2.0 wt. %, including all values and increments therein. Accordingly, the chemical crosslinking agent, such as the organic peroxides noted above, may be present in the polymer resin at a level of 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. % or 2.0 wt. %.

As may therefore be appreciated, upon heating of the polymer resin formed by the reaction of BA and CTS, now containing a chemical crosslinking agent such as dicumyl peroxide, at a preferred level of 0.1 wt. % to 2.0 wt. %, initial crosslinking of the polymer resin, prior to pyrolysis, occurs at relatively lower temperatures (e.g., less than or equal to 225° C.). Accordingly, this initial crosslinking of the polymeric resin is now preferably achieved prior to the higher pyrolysis temperatures (e.g., ≥800° C.) that are otherwise required for pyrolysis (thermal decomposition of the polymeric resin) to allow for ceramic formation.

The polymer derived ceramic so formed herein was evaluated using Scanning Electron Microscopy (SEM), Energy Dispersive X-Ray Spectroscopy (EDS), Powder X-Ray Diffraction (PXRD) and Laser-Induced Breakdown Spectroscopy (LIBS). The ceramics so produced indicated the presence of silicon (Si), oxygen (O), and carbon (C) atoms and is contemplated to also include relatively lower levels of boron (B) and nitrogen (N). In addition, it was observed that the surface of the derived ceramic revealed SiOC composition while the interior of the ceramic indicated SiC composition. Further, heating of the derived ceramic to temperatures above 1400° C. provides a ceramic with only SiC composition.

The above referenced initial and relatively lower temperature crosslinking that takes place prior to pyrolysis and ceramic formation can now be relied upon to increase ceramic yield. Ceramic yield is reference to the final weight after pyrolysis divided by the original polymeric resin weight times 100%. Accordingly, the use of an initial and relatively lower temperature crosslinking of the polymer resin produced by the reaction of BA and CTS can now be employed to provide for a ceramic yield after pyrolysis that is greater than or equal to 80.0%.

One may also optionally include one or more metal fillers into the polymer resin formed by the reaction of BA and CTS as described herein. Preferably, one employs an active metal filler which is understood as a metal filler that is capable of reacting with any by-products (e.g., gases) produced during the decomposition of the polymer resin to separately form metallic phases in the ceramic that is formed. Preferably, the metal filler is present in the polymer resin at a level of 2.0 wt. % to 25.0 wt. %, including all values and increments therein. One particularly preferred active metal filler is molybdenum (Mo). Metal fillers are therefore considered to include one or more of Mo, B, Si, Al, Ti, Ta, Nb, and Hf. Such metal fillers can also now be relied upon to further increase the ceramic yield of the polymer resin undergoing pyrolysis and conversion to a ceramic. That is, when now employing an initial and relatively lower temperature crosslinking of the BCTS polymer resin together with the addition of active metal fillers, the ceramic yield that one can achieve after pyrolysis is greater than or equal to 84.0%.

With respect to the boric acid component employed herein, one may preferably utilize an isotopically pure form of boric acid. That is, one may utilize a boric acid that is sourced from boron-10 (¹⁰B) or boron-11 (¹¹B). Such boric acid may be more specifically identified as boron-10 boric acid (H₃¹⁰BO₃) or boron-11 boric acid (H₃¹¹BO₃). Accordingly, when utilizing H₃¹⁰BO₃. the boron-modified cyclotrisilazane (BCTS) polymeric resin produced and/or the ceramic that is then produced herein is contemplated to then have material properties indicating relative higher amounts of thermal neutron absorption as opposed the use of natural abundance boric acid (e.g., 80% ¹¹B and 20% ¹⁰B) or H₃¹¹BO₃.

### WORKING EXAMPLES

### Control BCTS15 Resin

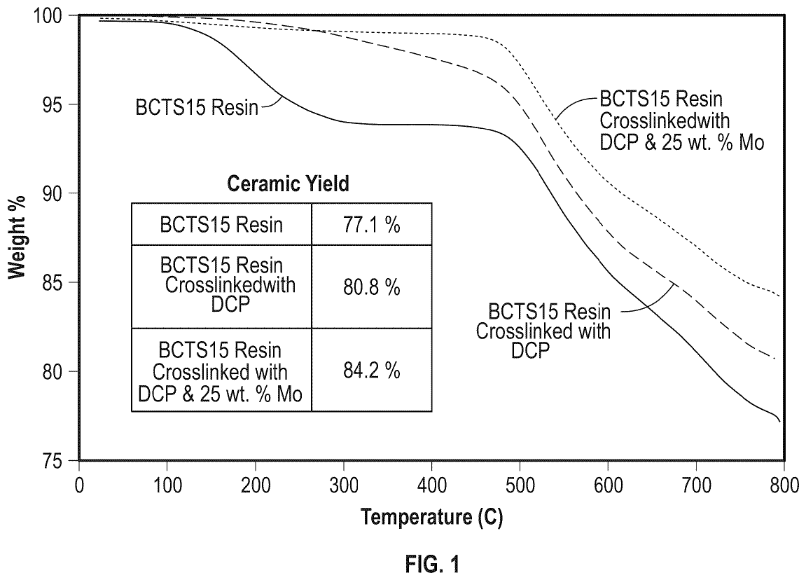

Boric acid (BA) and 2,4,6-trimethyl-2,4,6-trivinylcyclotrisilazane (CTS) were refluxed in the present of water where the molar ratio of BA to CTS was 1:5. A polymeric resin (BCTS15 Resin) was produced that was then converted by heating to the final ceramic in stages. Such heating and conversion can be monitored by thermal gravimetric analysis (TGA). At a temperature of 200° C. to 500° C., there was an observed loss of 7.0 wt. % of material. When heated above 500° C., significant decomposition of the polymeric resin is observed resulting in formation of ceramic materials composed primarily of silicon, oxygen and carbon atoms, with a ceramic yield of 77.1%. See FIG. 1 which is the TGA curve identifying the weight loss versus temperature of the control BCTS15 Resin and confirming the ceramic yield of 77.1%.

It can be noted that when the control BCTS15 resin was pyrolyzed at 1200° C. in Ar atmosphere, the ceramic produced appeared fully amorphous as evidenced by powder x-ray diffraction analysis (PXRD). Further, heating of such ceramic above 1400° C. resulted in carbothermal reduction to produce a silicon carbide like material.

### BCTS15 Resin Crosslinked With DCP Prior To Pyrolysis

Crosslinking agent, namely dicumyl peroxide at a level of 2.0 wt. % was combined into the BCTS15 resin to promote crosslinking at temperatures at or below 225° C. Namely, as noted above, DCP provides a decomposition temperature and generation of free radicals at temperatures in the range of 160° C. to 170° C. DCP was preferably incorporated into the BCTS15 resin by heating at 60° C. for about 20 minutes to melt it into the polymer. Another preferred route is to dissolve the DCP in a solvent such as dichloromethane and apply such solution to the polymer and remove the dichloromethane under vacuum prior to crosslinking. Crosslinking of the BCTS15 resin was then accomplished by heating at 160° C. for one hour. As illustrated in FIG. 1, TGA data confirmed that pyrolysis of crosslinked BCTS15 resin at temperatures up to 800° C. increased the ceramic yield to 80.8%.

### BCTS15 Resin Crosslinked With DCP Prior To Pyrolysis Including Active Filler

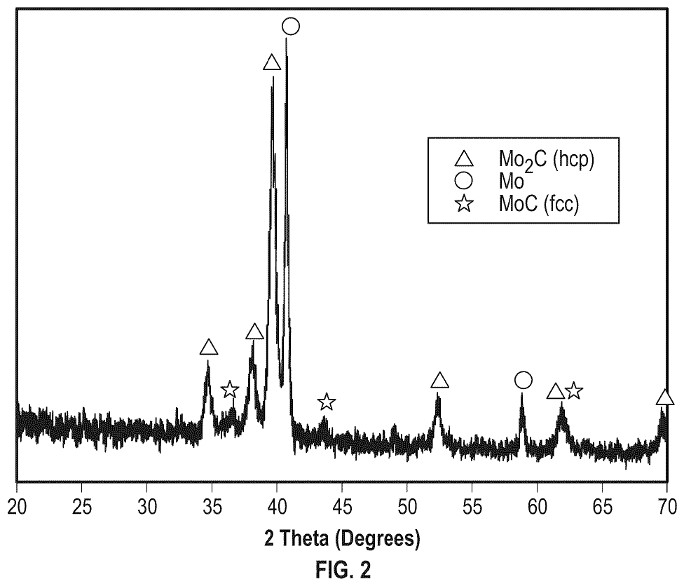

Similar to the above, crosslinking agent, namely dicumyl peroxide at a level of 2.0 wt. % was combined into the BCTS15 resin to promote crosslinking at temperatures at or below 225° C. In addition, an active metal filler, namely Mo, in the range of 2.0 wt. % to 25.0 wt. % was added to the BCTS15 resin, which all showed an increase in ceramic yield relative to the control BCTS15 resin. FIG. 1 TGA data shows the use of 25.0 wt. % Mo in the BCTS15 Resin crosslinked with DCP prior to pyrolysis where the ceramic yield reached 84.2%. Attention is directed to FIG. 2 which confirms that the ceramic product by pyrolysis included molybdenum carbide in either the Mo₂C hexagonal close packed of MoC face-centered cubic phase in addition to some unreacted Mo.

In addition to increased ceramic yield from the resins produced herein from the reaction of BA and CTS, it is contemplated that such ceramic formation is achieved with a reduction in shrinkage and porosity, and improved shape retention in relatively complex-shaped components. The ceramics so produced may then serve in applications demanding relatively high-temperature resistance along with resistance to oxidative and corrosive environments.

The ceramic materials produced herein are contemplated for applications where elevated temperature and chemical resistance are important. Such applications are contemplated to include utilization in pulse power systems, where the delivery of energy to a load, such as relatively high voltage or high-current by a generator, is conducted at relatively short time frames (e.g., pulses in the range of milliseconds to even picoseconds). Other contemplated applications include use as coatings on equipment or electric storage devices, to again, provide requisite heat and chemical resistance.

1. A method to form polymer derived ceramic material comprising:
a. reacting boric acid and 2,4,6-trimethyl-2,4,6-trivinylcyclotrisilazane and forming a polymeric resin;
b. incorporating a chemical crosslinking agent in said polymeric resin wherein said chemical crosslinking agent provides a source of free-radicals at temperatures of less than or equal to 225° C.;
c. heating said polymeric resin containing said chemical crosslinking agent and crosslinking said resin at temperatures at or below 225° C.; and
d. pyrolyzing said crosslinked resin produced in step (c) and forming a ceramic at a ceramic yield of greater than or equal to 80.0%.

2. The method of claim 1 wherein said boric acid and 2,4,6-trimethyl-2,4,6-trivinylcyclotrisilazane are reacted at a molar ratio of boric acid to said 2,4,6-trimethyl-2,4,6-trivinylcyclotrisilazane of 1.0:>1.0 to 1:5.

3. The method of claim 1 wherein said boric acid and 2,4,6-trimethyl-2,4,6-trivinylcyclotrisilazane are reacted at a molar ratio of boric acid to said 2,4,6-trimethyl-2,4,6-trivinylcyclotrisilazane of >1.0:1.0 to 5.0:1.0.

4. The method of claim 1 wherein said polymeric resin has a number average molecular weight in the range of 1000 to 5000.

5. The method of claim 1 wherein said polymeric resin has a weight average molecular weight in the range of 1,500 to 7,500.

6. The method of claim 1 wherein said polymeric resin comprises a random copolymer having the following repeating units: 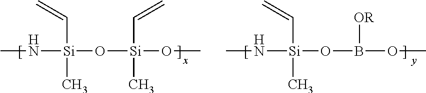
where R is either a hydrogen or a linkage to a boron atom in another repeating unit therefore providing one the following:

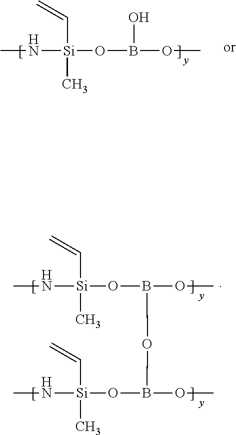

7. The method of claim 1 wherein said chemical crosslinking agent comprises a peroxide.

8. The method of claim 7 wherein said peroxide comprises an organic peroxide.

9. The method of claim 1 wherein said chemical crosslinking agent is present in said polymeric resin at a level of 0.1 wt. % to 2.0 wt. %.

10. The method of claim 8 wherein said chemical crosslinking agent is selected from dicumyl peroxide, tert-butylperoxybenzoate or dibenzoyl peroxide.

11. The method of claim 1 further including an active metal filler in said polymeric resin prior to heating and crosslinking, wherein said active metal filler comprises one or more of Mo, B, Si, Al, Ti, Ta, Nb, and Hf.

12. The method of claim 11 wherein said active metal filler is present at a level of 2.0 wt. % to 25.0 wt. %.

13. The method of claim 11 wherein said ceramic yield is greater than or equal to 84.0%.

14. The method of claim 1 wherein said boric acid comprises H₃¹⁰BO₃.

15. A method to form polymer derived ceramic material comprising:
a. reacting boric acid and 2,4,6-trimethyl-2,4,6-trivinylcyclotrisilazane and forming a polymeric resin;
b. incorporating a chemical crosslinking agent in said polymeric resin wherein said chemical crosslinking agent provides a source of free-radicals at temperatures of less than or equal to 225° C.;
c. exposing said polymeric resin containing said chemical crosslinking agent to ultraviolet radiation and crosslinking said resin at temperatures at or below 225° C.; and
d. pyrolyzing said crosslinked resin produced in step (c) and forming a ceramic at a ceramic yield of greater than or equal to 80.0%.

16. The method of claim 15 wherein said boric acid and 2,4,6-trimethyl-2,4,6-trivinylcyclotrisilazane are reacted at a molar ratio of boric acid to said 2,4,6-trimethyl-2,4,6-trivinylcyclotrisilazane of 1.0:>1.0 to 1:5.

17. The method of claim 15 wherein said boric acid and 2,4,6-trimethyl-2,4,6-trivinylcyclotrisilazane are reacted at a molar ratio of boric acid to said 2,4,6-trimethyl-2,4,6-trivinylcyclotrisilazane of >1.0:1.0 to 5.0:1.0.

18. The method of claim 15 wherein said polymeric resin has a number average molecular weight in the range of 1000 to 5000.

19. The method of claim 15 wherein said polymeric resin has a weight average molecular weight in the range of 1,500 to 7,500.

20. The method of claim 15 wherein said polymeric resin comprises a random copolymer having the following repeating units: 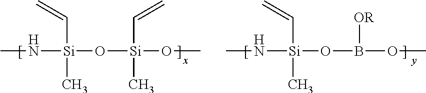
where R is either a hydrogen or a linkage to a boron atom in another repeating unit therefore providing one the following:

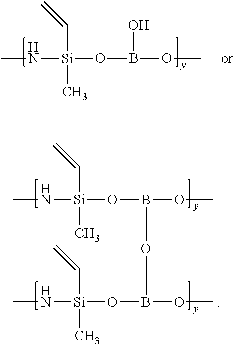

21. The method of claim 15 wherein said chemical crosslinking agent comprises a peroxide.

22. The method of claim 21 wherein said peroxide comprises an organic peroxide.

23. The method of claim 15 wherein said chemical crosslinking agent is present in said polymeric resin at a level of 0.1 wt. % to 2.0 wt. %.

24. The method of claim 22 wherein said chemical crosslinking agent is selected from dicumyl peroxide, tert-butylperoxybenzoate or dibenzoyl peroxide.

25. The method of claim 15 further including an active metal filler in said polymeric resin prior to heating and crosslinking, wherein said active metal filler comprises one or more of Mo, B, Si, Al, Ti, Ta, Nb, and Hf.

26. The method of claim 25 wherein said active metal filler is present at a level of 2.0 wt. % to 25.0wt. %.

27. The method of claim 25 wherein said ceramic yield is greater than or equal to 84.0%.

28. The method of claim 15 wherein said boric acid comprises H₃¹⁰BO₃.
